(19) United States
(12) Patent Application Publication
(10) Pub. No.: US 2005/0146156 A1
(43) Pub. Date: Jul. 7, 2005

(54) Device for locking and/or unlocking a tank flap

(76) Inventors: Marcus Busch, Lehrte (DE); Etzhard Bultmann, Wedemark (DE)

Correspondence Address: MCGUIREWOODS, LLP, 1750 TYSONS BLVD, SUITE 1800, MCLEAN, VA, 22102, US

(21) Appl. No.: 10/974,017

(22) Filed: Oct. 27, 2004

(30) Foreign Application Priority Data
Oct. 29, 2003 (DE) 103 50 470.2

(51) Int. Cl. B62D 25/00

(52) U.S. Cl. 296/97.22

(57) ABSTRACT

A device for locking and/or unlocking a tank flap (1), especially on motor vehicles, the tank flap (1) being lockable via a receptacle element (2) and a locking part (3), which for locking is in a positive lock engagement with the receptacle part (2), the tank flap (1) being assigned a switching element (4), which, when there is pressure on the tank flap (1), activates an actuator, which is linked to the locking part (3) and brings the locking part (3) into and/or out of engagement with the receptacle element (2).

### FIELD OF THE INVENTION

The invention relates to a device for locking and/or unlocking a tank flap, especially on motor vehicles, wherein the tank flap is lockable via a receptacle element and a locking part that has a positive engagement with the receptacle element.

### DESCRIPTION OF THE RELATED ART

Devices for locking or unlocking a tank flap are known in the art for which a tab having a through hole, in which a locking part is inserted for locking, is formed on the tank flap. This insertion or removal for unlocking is accomplished via positioning a motor drive, hydraulically, pneumatically or via a solenoid switch. After the unlocking, the vehicle user must grip behind the tank flap, which is sometimes difficult.

### SUMMARY OF INVENTION

The object of the invention is to provide a device for locking and/or unlocking a tank flap that enables an easier opening of the tank flap.

According to the invention, the tank flap is assigned a switching element, which, when there is pressure on the tank flap, activates an actuator that brings the locking part into and/or out of engagement with the receptacle element. By pressure on the tank flap, the switch element is triggered, which relays the pulse to the actuator, for example, a positioning motor or a solenoid switch, and displaces or swivels the locking part. Therefore, the flap remains completely locked until an appropriate stimulus is applied from outside on the tank flap. As soon as the switching element is activated, the tank flap is released and can easily be opened.

Advantageously, the switching element is designed as a microswitch, which is either attached together with the actuator to the tank flap or is housed within the motor vehicle, for example in a filler-neck compartment or in a housing.

The invention provides that the receptacle element or also the tank flap is assigned a spring element, which in the locked state of the tank flap loads it in the opening direction so that after an unlocking it flips out from the locking position and projects past the vehicle outer skin, which normally forms a contour with the tank flap. As a result, the full opening of the tank flap is made easier. By virtue of the spring loading and application of a force via the spring element, the receptacle element is pressed against the locking part if it is in positive engagement with the receptacle element. In this way, a rattling of the tank flap is prevented, because the receptacle element is twisted in relation to the locking part.

One embodiment of the invention provides that the spring element is disposed between the switching element and the tank flap or the reception element so that the switching element also acts as a spring-loaded momentary-contact switch and the tank flap can press up or press out. Advantageously, the spring element is designed in such a manner that the tank flap in the unlocked state is swung out from the locking position and therefore projects past the vehicle outer skin.

### BRIEF DESCRIPTION OF DRAWINGS

An exemplary embodiment of the invention is explained in detail below with reference to the accompanying FIGURE.

FIG. 1 a first variant of the device in accordance with the invention.

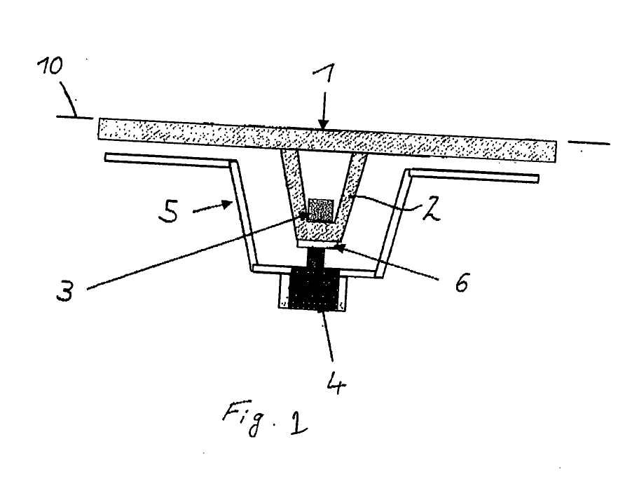

### DETAILED DESCRIPTION OF EMBODIMENTS

An exemplary embodiment is explained in reference to the attached FIGURE, which shows a cross-sectional view of an embodiment. The FIGURE shows a tank flap 1, which closes essentially flush with a vehicle outer skin 10 so as to configure a nearly closed contour line of a vehicle body. At tank flap 1, a receptacle element 2 is formed as a bow, which is attached or integrally formed on the inner side of the tank flap 1. A locking part 3, which is fixed on a housing 5 or on the vehicle body, engages in this receptacle element. By means of the positive engagement of locking part 3 in receptacle element 2, the tank flap 1 is locked in the illustrated position. A spring element 6, which at the same time is coupled to a microswitch 4, is configured below receptacle element 2. If the tank flap 1 is then moved in the direction of microswitch 4, which is possible within the context of flap overtravel; that is, when there is play in the closed state, the microswitch 4 is activated, whereupon an actuator (not shown), such as a positioning motor or a solenoid switch, is activated. This actuator moves locking part 3 out from receptacle element 2 and enables a swiveling of the tank flap 1 into an open position. Simultaneously with the unlocking, the receptacle element 2 and with it the tank flap 1 is pressed out in the direction of switching element 4 by the spring element 6 so that the tank flap 1 projects out from the vehicle outer skin 10, and it is possible to simply grab behind it and open it for tank filling.

Alternatively to the configuration of the spring element 6 on microswitch 1, provision is made that a spring acts on the axis of rotation of the tank flap 1 and presses it into an open position.

To lock the tank flap 1, it is swiveled from the open position into the closed position, and the microswitch 4 is activated by the tank flap overtravel. Consequently, the pulse is transmitted to the non-depicted positioning motor or solenoid switch, which shifts or swivels the locking part 3 in the opposing direction and brings it into positive engagement with the receptacle element 2.

A locking or unlocking is thereby directly effected on tank flap 1, whereby a break of the circuit is provided between switching element 4 and actuator.

In principle it is possible to integrate both the microswitch 4 and spring element 6 in the tank flap 1 and provide a receptacle element 2 in housing 5 or on the vehicle body.

The contents of the German application No. 103 50 470.2 is incorporated herein in its entirety by reference.

1. A device for locking and/or unlocking a tank flap, especially on motor vehicles, the tank flap being lockable via a receptacle element and a locking part, which for locking is in a positive lock engagement with the receptacle part, the tank flap being assigned a switching element, which, when there is pressure on the tank flap, activates an actuator, which is linked to the locking part and brings the locking part into and/or out of engagement with the receptacle element.

2. The device as described in claim 1, wherein the actuator is a positioning motor or a solenoid switch that displaces or swivels the locking part.

3. The device as described in claim 1, wherein the switching element is a microswitch.

4. The device as described in claim 1, wherein the receptacle element is assigned a spring element, which in a locked state of the tank flap loads it in an opening direction.

5. The device as described in claim 1, further comprising a spring element disposed between the switching element and the tank flap or receptacle part.

6. The device as described in claim 1, further comprising a spring element is designed in such a way that the tank flap in the unlocked state is swiveled out from a locking position.
